(19) United States
(12) Patent Application Publication
(10) Pub. No.: US 2012/0042354 A1
(43) Pub. Date: Feb. 16, 2012

(54) Entitlement conflict enforcement

(75) Inventors: Anthony Vitiello, Mentor, OH (US); Anoop Kanthan, New York, NY (US); Paul Edward Carpenter, Stamford, CT (US)

(73) Assignee: Morgan Stanley, New York, NY (US)

(21) Appl. No.: 12/806,512

(22) Filed: Aug. 13, 2010

(51) Int. Cl. G06F 21/00

(52) U.S. Cl. 726/1

(57) ABSTRACT

Various embodiments are directed to entitlements clearance. For example, an entitlement clearance request may be received from a provisioning application. The entitlement clearance request may comprise an indication of a subject entitlement and an indication of a subject user. An indication of user characteristics describing the subject user and an indication of existing entitlements held by the subject user may be received. A plurality of entitlements conflict rules may be applied to the existing entitlements, the subject entitlement and the user characteristics to determine whether an entitlements conflict exists in view of the subject entitlement. In addition, a completion indication of whether the entitlements conflict exists in view of the subject entitlement may be returned. Provided that the entitlements conflict exists, the completion indication may comprise an indication of at least one entitlements conflict rule selected from the plurality of entitlements conflict rules that would be violated by the subject entitlement.

### BACKGROUND

Many organizations rely on computer systems to perform and/or facilitate business functions. For example, firms in the financial services-industry often rely on computer systems to store and access client data, execute trades on behalf of clients and the firm, generate and authorize payments to and from customers, vendors, etc. Such computer systems often include entitlement management functionality to verify that users making requests to access system resources are entitled to do so. Each system user may be assigned one or more entitlements, with each entitlement allowing the user to access a system resource and/or perform a particular action. Upon receiving a request from the user, the entitlement management functionality determines whether the user possesses the proper entitlement for the requested access.

Entitlements are defined and assigned in different ways. Some entitlements are defined as a list of entitled users. Other entitlements are defined as a characteristic or set of characteristics describing entitled users. Users having the recited characteristics are determined to possess the entitlement. Example user characteristics that may be relevant to entitlement determination may include the user's job function or role, assigned department or cost center, etc. It is common to have more than one source of entitlements in a computer system. For example, multiple administrators may have the ability to add or remove a user from a list of entitled users. Multiple entitlement provisioning systems or applications may be used to determine entitlements. Also, multiple applications and/or users may have the ability to change user data in a manner that results in an entitlement change (e.g., moving a user from one department or another, changing a characteristic of a user, etc.). This can result in undetected entitlement conflicts.

### FIGURES

Various embodiments of the present invention are described here by way of example in conjunction with the following figures, wherein:

FIG. 1 illustrates a block diagram of one embodiment of an entitlement management system implementing entitlements conflict enforcement.

FIG. 2 is a flow chart illustrating one embodiment of a process flow of the entitlement clearance application of the entitlement management system of FIG. 1.

FIG. 3 illustrates a flow chart showing one embodiment of a process flow for handling an entitlement conflict detected by the entitlement clearance application for a provisioning application.

FIG. 4 illustrates a flow chart showing another embodiment of a process flow for handling an entitlement conflict detected by the entitlement clearance application for a provisioning application.

FIG. 5 illustrates a flow chart showing one embodiment of a process flow for handling an entitlement conflict detected by the entitlement clearance application in response to changes in reference data.

FIG. 6 illustrates a hardware diagram of one embodiment of a computer system that may implement entitlements conflict enforcement, as described herein.

### DESCRIPTION

Various embodiments are directed to systems and methods for providing entitlement conflicts enforcement to actual or requested entitlements in a computer system. An entitlement may be an authorization for a computer and/or human user to utilize a system resource. Utilizing a system resource may involve viewing and/or modifying a resource, such as a record or other data. Utilizing a system resource may also involve utilizing the computer system to perform an action (e.g., initiating or authorizing a transaction).

An entitlement conflict may exist when a user possesses an entitlement that conflicts with another entitlement held by the user and/or with a characteristic of the user. A conflict between entitlements may exist when a single user possesses one or more entitlements that allow the user to utilize a combination of resources that should not be used by the same individual, for example, to avoid the potential for actual or apparent impropriety, to comply with regulatory requirements, etc. An example conflict between entitlements may exist when a single user possess an entitlement to execute a trade as well as an entitlement to authorize the same trade. A conflict between an entitlement and a user characteristic may exist when a user is granted an entitlement that should not be granted to the user based on one or more user characteristics. For example, an entitlement conflict may exist if a user assigned to a department on the buy-side of a financial services firm is granted an entitlement to utilize resources on the sell-side of the firm.

According to various embodiments, one or more entitlement clearance applications may execute as callable services on a computer system. Applications that modify or detect changes in entitlements may call the entitlement clearance application to request entitlement conflict clearance of a new or existing entitlement. For example, before granting an entitlement to a user or group of users, entitlement provisioning applications or services may direct an entitlement clearance request to the entitlement clearance application. Entitlement clearance requests directed to the entitlement clearance application may comprise an indication of the subject entitlement including an indication of the relevant user or group of users (e.g., an employee identifier, etc.). In response to the entitlement clearance request, the entitlement clearance application may retrieve data describing pre-existing entitlements and/or other characteristics of each user or group of users that is the subject of the entitlement. The entitlement clearance application may determine whether the combination of the requested entitlement and the pre-existing entitlements and/or characteristics would violate any of a set of entitlement conflict rules. The entitlement clearance application may return to the provisioning application an indication that the requested entitlement either would or would not generate an entitlement conflict. When an existing or potential conflict is detected, the entitlement clearance application may also return an indication of an entitlement conflict rule that would be violated by the requested entitlement.

One or more entitlement conflict exception applications may also be implemented. Upon determining that a requested entitlement would create an entitlement conflict, an exception request may be sent to an entitlement conflict exception application, for example, by the entitlement conflict application and/or the provisioning application. The entitlement conflict exception application may implement a workflow for determining whether the detected conflict should be allowed or rejected. For example, the entitlement conflict exception application may route the request to administrative personnel.

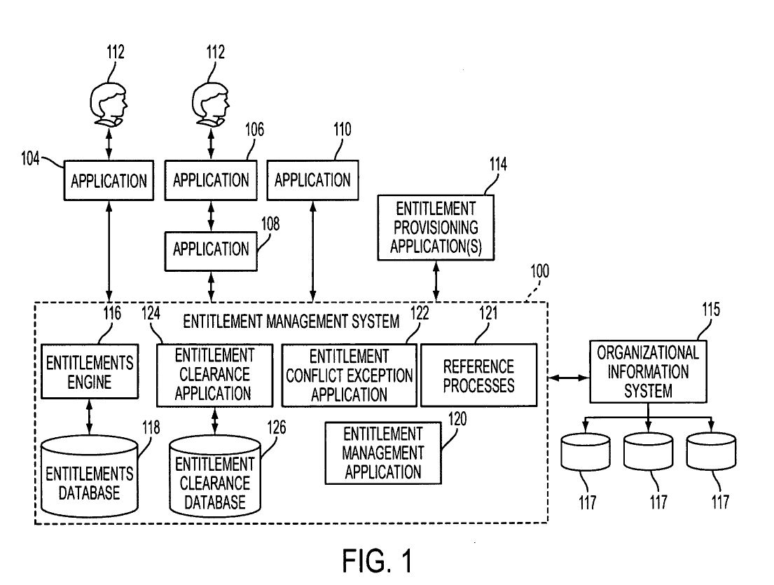

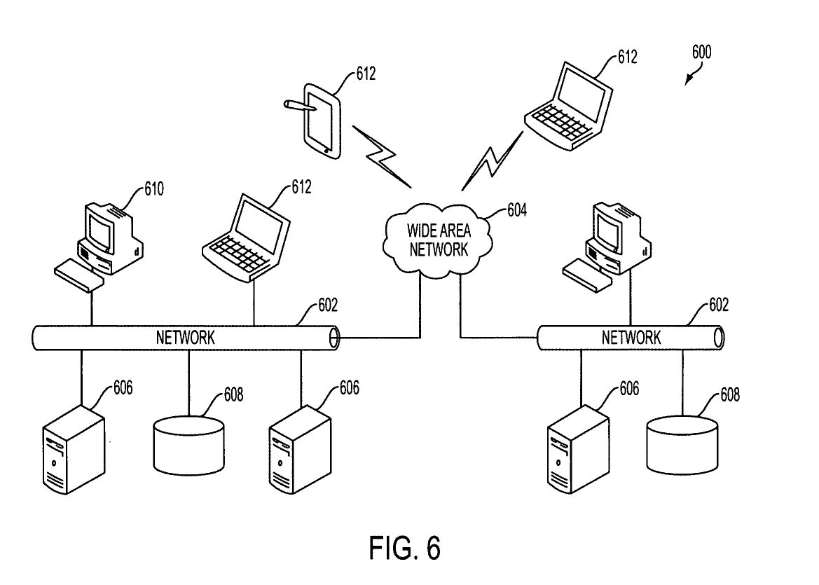

FIG. 1 illustrates a block diagram of one embodiment of an entitlement management system 100 implementing entitlements conflict enforcement. The entitlements management system 100 is illustrated in communication with other computer network elements including, for example, general applications 104, 106, 108, 110, an external entitlement provisioning application 114 and an organizational information system 115. FIG. 1 also illustrates several human operators 112 utilizing applications 104, 106, 108, 110. The various functional components illustrated in FIG. 1 may be executed by a computer system, such as the computer system 600 illustrated below in FIG. 6. It will be appreciated, however, that some or all of the functional components illustrated in FIG. 1 may be implemented by a single computer device and/or by a computer system having a configuration different than that of the system 600.

The general applications 104, 106, 108, 110 may implement functionality for performing various business functions and/or accessing firm resources. In the context of a financial services firm, example functionality provided by one or more of the general applications 104, 106, 108, 110 may comprise creating, updating, deleting or approving payments and other transactions, viewing, editing or deleting transactions on firm accounting journals, etc.

Before accessing a firm resource or performing a business function, each application 104, 106, 108, 110 may request authorization from the entitlement management system 100. If the user of the requesting application 104, 106, 108, 110 possesses the proper entitlement, authorization may be granted. The user who must possess the appropriate entitlement may be a human operator 112 or, in various embodiments, may be an application itself. For example, the application 104 may comprise functionality allowing the human operator 112 to access firm resources and/or perform business functions. When the human operator 112 instructs the application 104 to perform a task that requires an entitlement, the application 104 may verify the human operator's 112 entitlement with the entitlement system 100. In this case, the human operator may be the user, and the entitlement system 100 may determine whether the human operator 112 possesses the required entitlement. In some embodiments, a human user 112 may operate via a direct application 106 and an intermediate application 108. The intermediate application 108 may, in the course of its operation, have need to perform an entitled business task and/or access a protected resource. In this case, the entitlement system 100 may consider the entitlements of the human operator 112, the applications 106, 108, or some combination thereof. According to various embodiments, an application, such as application 110 may not have an associated human operator 112. In such cases, the application 110 itself may be considered the user whose entitlements may be verified by the entitlement management system 100 prior to allowing access to a protected resource or authorizing an entitled action.

The entitlement management system 100 may perform various entitlement-related tasks including, for example, determining entitlements, handling requests for entitled actions, provisioning entitlements, clearing entitlements for potential conflicts, and exception handling. At least one entitlements engine 116 may handle requests for entitled actions. The entitlements engine 116 may be in communication with an entitlements database 118 that may store entitlements data indicating entitlements associated with various users and/or groups of users. In some embodiments, the entitlements database 118 may also store entitlements data in the form of entitlements rules indicating characteristics of users entitled to perform an action or access a resource. Although FIG. 1 shows a single entitlements engine 116, some embodiments may comprise multiple federated entitlements engines 116, with each entitlements engine 116 configured to serve a subset of all applications 104, 106, 108, 110. It will be appreciated that the entitlements engine 116 may operate according to any suitable method. Example entitlement management systems are described, for example, in U.S. patent application Ser. No. 10/930,642, entitled “Organizational Reference Data and Entitlement System” and U.S. patent application Ser. No. 11/519,378 entitled, “Organizational Reference Data and Entitlement System with Entitlement Generator,” which are both incorporated herein by reference in their entirety.

At least one entitlement management application 120 may provide functionality for allowing users to provision entitlements. For example, the entitlement management application 120 may facilitate the association of groups of users to corresponding groups of entitlements. In various embodiments, one or more entitlement management applications 120 may facilitate the ad hoc provision of entitlements, for example, to individual users. In various embodiments, one or more external entitlement provisioning applications 114 may also be present. The entitlement provisioning applications 114 may generally assign entitlements to users in a manner similar to the entitlement management application 120.

According to various embodiments, at least one reference process 121 may monitor reference data for changes that impact entitlements. For example, the reference process 121 may be in communication with an organizational information system 115 that may store characteristics for various users. Characteristics describing a user may comprise, for example, names, roles, teams, relationships, departments, coverages, etc. The reference process 121 may monitor the organizational information system 115 for changes that impact entitlements (e.g., changes to any user's characteristics that would cause them to gain or lose an entitlement). The organizational information system 115 may be in communication with one or more internal or external databases 117 storing information describing various users. It will be appreciated that the organizational information system 115 may be implemented in any suitable manner. For example, the organizational information system 115 may be a standard human resources computer database system. Additional example embodiments of the organizational information system 115 are described, for example, in U.S. patent application Ser. No. 10/930,642, entitled “Organizational Reference Data and Entitlement System” and U.S. patent application Ser. No. 11/519,378 entitled, “Organizational Reference Data and Entitlement System with Entitlement Generator,” which are both incorporated herein by reference in their entirety.

The entitlement clearance application 124 may be in communication with one or more of the applications 104, 106, 108, 110 to clear potential or existing entitlements. According to various embodiments, the entitlement clearance application 124 may be in communication with an entitlement clearance database 126. The entitlement clearance database 126 may store entitlement conflicts rules for determining whether a potential or existing entitlement generates a conflict. The entitlement conflict exception application 122 may be called when a conflict is determined and may be configured to determine whether to allow or disallow the offending entitlement in view of the conflict.

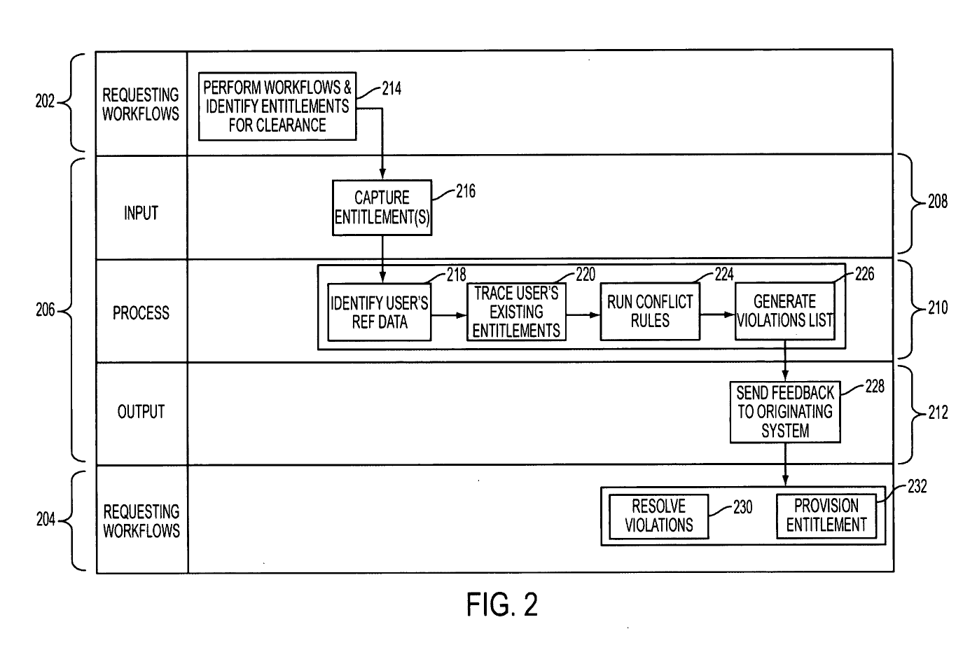

FIG. 2 is a flow chart illustrating one embodiment of a process flow 200 of the entitlement clearance application 124. The flow chart 200 comprises columns 202, 204, 206 indicating the acting party for the respective actions. Rows 202 and 204 represent actions of the requesting workflows, while rows 206 represents actions of the entitlement clearance application 124. At 214, the requesting workflow may, in the course of its operation, identify one or more entitlements for clearance. Upon identification of an entitlement for clearance, an entitlement clearance request may be transmitted to the entitlement clearance application 124. The entitlement clearance request may identify the one or more entitlements for clearance, referred to herein as the subject entitlement or entitlement. The requesting workflows may be any application or workflow requesting conflict clearance of an entitlement or user. One example of a requesting workflow may be an entitlement provisioning application 114. For example, when provisioning an entitlement to a user, the entitlement provisioning application 114 may request entitlement conflict clearance of the proposed entitlement. Another example of a requesting workflow may be an entitlement management application 120, also configured to provision entitlements to one or more users. For example, when provisioning an entitlement or entitlements to a user or user, the entitlement management application 120 may request entitlement conflict clearance of the entitlement or user. In various embodiments, a reference process 121 may be the requesting workflow. For example, when the reference process 121 detects a change of reference data (e.g., at the organizational information system 115) that affects an entitlement, the reference process 121 may request an entitlement conflict clearance of the affected entitlements and/or users.

The row 206, indicating actions of the entitlement clearance application 124, may be divided into three sub-rows 208, 210, 212. Sub-row 208 may indicate input actions, representing input data parameters passed to the entitlement clearance application 124 by the requesting workflow. Sub-row 210 may indicate process steps performed by the entitlement clearance application 124. Sub-row 212 may indicate output provided by the entitlement clearance application 124 to the requesting workflow. At 216, the entitlement clearance application 124, may receive the entitlement clearance request from the requesting workflow. The request may comprise various data describing the request including, for example, a subject entitlement or entitlements and an affected user or users.

At 218, the entitlement clearance application 124 may identify and obtain reference data describing the user or users identified by the request. For example, the entitlement clearance application may direct a request to the organizational information system 115 to obtain user characteristics. Alternatively, user reference data may be obtained by the requesting workflow and passed to the entitlement clearance application 124 as a part of the request. At 220, the entitlement clearance application 124 may identify and obtain data describing existing entitlements of the user or users identified by the request. According to various embodiments, this user entitlement data may be obtained by the requesting workflow and passed to the entitlement clearance application 124 as a part of the request.

At 224, the entitlement clearance application 124 may evaluate the subject entitlement or entitlements in view of the reference data for the identified user or users and the existing entitlements of the identified user or users. Evaluating the subject entitlement or entitlements may comprise evaluating a plurality of entitlement conflict rules on the combination of the subject entitlement or entitlements, the user or users' existing entitlements, and the user or users' characteristics. The entitlement conflict rules may be stored at the entitlement clearance database 126 and may, for example, be set and/or modified by a system administrator. According to various embodiments, the entitlement conflict rules may be broken into two categories: organization-based or one-sided rules and application-based or two-sided rules. One-sided and two-sided rules may be applied together, or separately.

Organization-based rules may identify forbidden combinations of entitlements and user characteristics. Organization-based rules may be designed to implement company policy and/or regulatory requirements. Examples of organization-based rules in a financial services firm comprise the following:

(1) Any user who is not an Operations employee may not be granted an entitlement allowing the user to create, update, delete or approve:
(a) standing payment and delivery instructions;
(b) security delivery and receipts;
(c) match downs or assign breaks; or
(d) custody of physical assets.

(2) Any user who is neither an Operations employee nor a Controller may not be granted an entitlement allowing the user to create, update, delete or approve manual journal entries.

(3) Any user who is a buy-side employee may not have access to any sell-side applications or data.

Application-based rules may identify forbidden combinations of entitlements. Application-based rules may be designed to implement company and/or regulatory policies for preventing improper activities or, in some cases, even the appearance of improper activities. Examples of application-based rules in a financial services firm comprise the following:

(1) Any user with an entitlement to create, update, delete or approve standing payment and delivery instructions may not be granted an entitlement to create update, delete or approve payments, deliveries or manual journals;

(2) Any user with an entitlement to create, update, delete or approve standing payment and delivery instructions may not be granted an entitlement to create, update, delete or approve match-downs or assign breaks on cash balances or securities positions within cash or securities reconciliation systems; and

(3) Any user with an entitlement to authorize cash payments or security deliveries may not be granted an entitlement to create, updated, delete or approve manual journals. Although the organization and application-based rule examples presented herein are negative, it will be appreciated that, in some embodiments, entitlements conflict rules may be positive (e.g., all users belonging to a given cost center should have access to a given resource).

At 226, the entitlement clearance application 124 may generate a list of entitlement conflicts, if any, that exist with the combination of the subject entitlement, the user or users existing entitlements and the user or users characteristics. At 228, the entitlement clearance application may generate a completion indication and transmit the completion indication to the requesting workflow. The completion indication may indicate whether the subject entitlement or entitlements generated any violations. In the event that entitlement conflicts were generated, then the completion indication may comprise an indication of the entitlement conflict rule that was violated. In various embodiments, the completion indication may also comprise information about the violation including, for example, an indication of the existing entitlement and/or user characteristic that conflicted with the subject entitlement, an indication of whether the violated rule was organization-based or application-based, etc.

Upon receipt of the completion indication, the requesting workflow may continue its processing. For example, in embodiments where the requesting workflow is configured to provision entitlements, it may resolve entitlement violations resulting from the subject entitlement (230) using, for example, the entitlement conflict exception application 122. If resolution is possible, the requesting workflow may provision the subject entitlement to the subject user or users (232). In the even that no entitlement conflicts were detected, the requesting workflow may simply provision the subject entitlement (232). In various other embodiments, for example, the subject entitlement may be provisioned before the entitlement clearance application 124 is called. For example, when a reference process 121 detects a change in reference data, the resulting changes in entitlements may already have occurred. Also, for example, the entitlement clearance application 124 may be periodically called in a batch mode to analyze previously issued entitlements. In these situations, the requesting workflow may identify ways to resolve the conflict that may include, for example, revoking an entitlement of the user or users and/or modifying user characteristics.

According to various embodiments, the entitlement clearance application 124 may be configured to execute in real time or in a batch mode. For example, the entitlement clearance application 124 may be configured to operate in real time in response to a request from an entitlement provisioning application 114, entitlement management application 120 or other requesting workflow that is evaluating the provisioning of a new entitlement. In real time, the entitlement clearance application 124 may execute upon receipt of an entitlement clearance request. In batch mode, the entitlement clearance application 124 may not execute immediately upon receipt of an entitlement clearance request. Instead, the entitlement clearance application 114 may execute at a later time, for example, when load on system resources is low. Batch mode may be utilized, for example, to evaluate changes in reference data affecting entitlements. In these cases, there may not be a user waiting to receive an entitlement, making the processing less urgent.

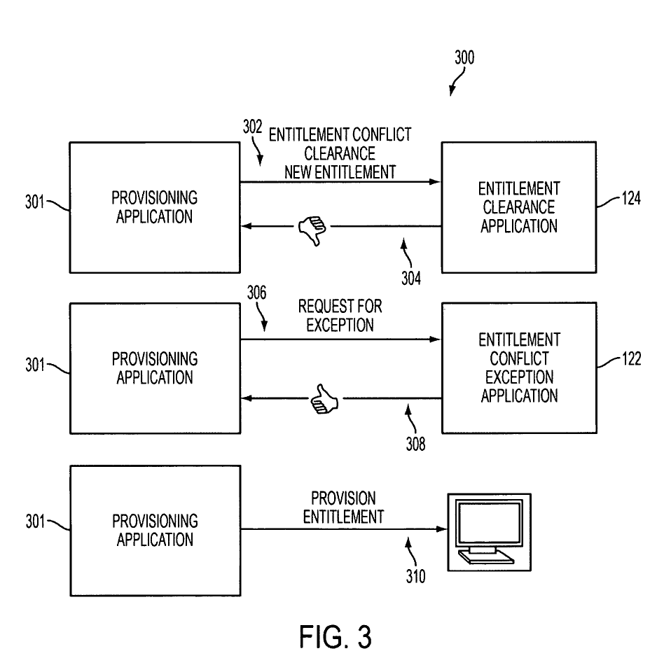

FIG. 3 illustrates a flow chart showing one embodiment of a process flow 300 for handling an entitlement conflict detected by the entitlement clearance application 124 for an entitlement provisioning application 114, management application 120 or other application provisioning entitlements (generally referred to in FIG. 3 as a provisioning application 301). At 302, the provisioning application 301 may direct an entitlement clearance request for a new subject entitlement to the entitlement clearance application 124. The entitlement clearance application 124 may evaluate the request, for example, as described above with reference to the process flow 200. In the example shown in FIG. 3, the entitlement clearance application may determine that the new subject entitlement creates an entitlement conflict and indicate the same to the provisioning application 301 at 304.

At 306, the provisioning application may generate a request for exception and transmit the request to the entitlement conflict exception application 122. The entitlement conflict exception application 122 may manage an evaluation of the conflict identified by the entitlement clearance application 124. According to various embodiments, the entitlement conflict exception application 122 may route the exception request to an administrator, who may manually evaluate whether an exception is appropriate. In the example shown in FIG. 3, the entitlement conflict exception application 122 may grant the exception request at 308. Accordingly, the provisioning application 301 may provision the new subject entitlement at 310. Also, as described herein, the exception application 122 may execute after an entitlement has been provisioned.

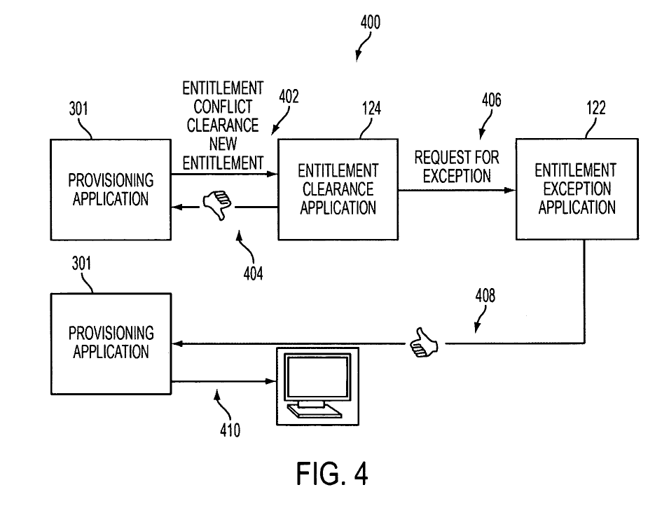

FIG. 4 illustrates a flow chart showing another embodiment of a process flow 400 for handling an entitlement conflict detected by the entitlement clearance application 124 for a provisioning application 301. At 402, the provisioning application 301 may direct an entitlement clearance request for a new subject entitlement or entitlements to the entitlement clearance application 124. The entitlement clearance application 124 may evaluate the request, for example, as described above with reference to the process flow 200. In the example shown in FIG. 4, the entitlement clearance application may determine that the new subject entitlement creates an entitlement conflict and indicate the same to the provisioning application 301 at 404. At 406, the entitlement clearance application 124 may call the entitlement exception application 122 and provide the entitlement exception application 122 with parameters for evaluating the detected conflict. At 408, the entitlement exception application may indicate its result directly to the provisioning application 301. In the example shown in FIG. 4, the entitlement exception application has approved an exception to the detected conflict. Accordingly, the provisioning application may provision the new subject entitlement or entitlements at 410.

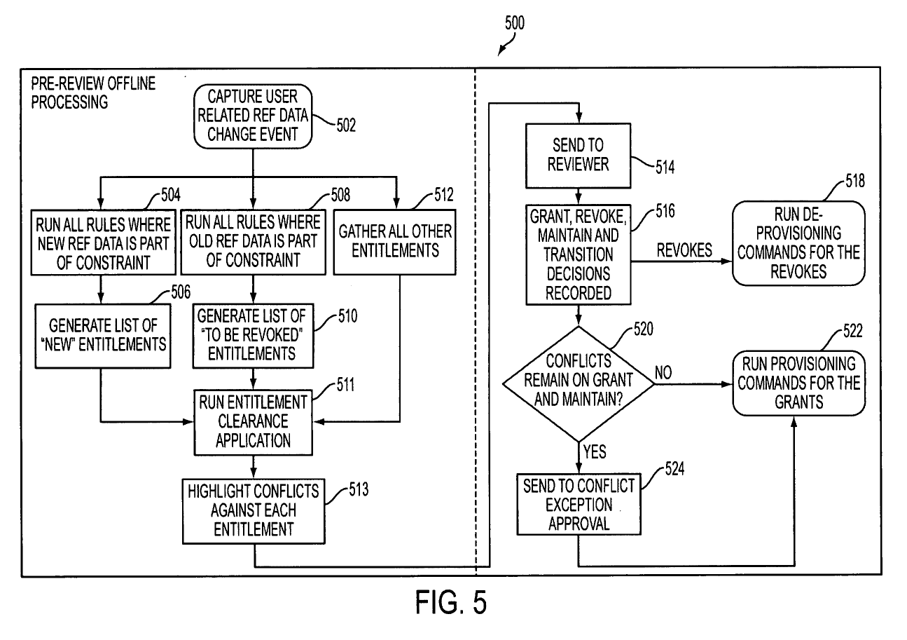

FIG. 5 illustrates a flow chart showing one embodiment of a process flow 500 for handling an entitlement conflict detected by the entitlement clearance application 124 in response to changes in reference data and/or in a batch mode. It will be appreciated that the actions of the process flow 500 may be performed by any combination of applications including, for example, the entitlement clearance application 124, the reference process 121, an entitlements conflict exception process 122, the entitlement provisioning application 114, the entitlement management application, the entitlements engine 116, etc. At 502, a reference data change may be detected, for example, by a reference process 121. At 504, entitlement rules may be applied considering the reference data change to generate a list of new entitlements at 506. The entitlement rules, which may be stored at entitlements database 118, may be rules that define users entitled to perform an action or access a resource in terms of their user characteristics. Accordingly, applying the entitlement rules to the updated reference data may result in a list of entitlements in view of the reference data change. This may be compared to a list of entitlements under the reference data prior to the change to return the list of new entitlements. At 508, the entitlement rules may be run against the reference data without considering the reference data change. The result may be a list of entitlements as existed prior to the reference data change. This may be compared to the list of entitlements in view of the reference data change to generate a list of entitlements that are revoked as a result of the reference data change. At 512, all other entitlements may be gathered.

At 511, the entitlement clearance application 124 may be called considering the list of new entitlements and existing entitlements. (In some embodiments, the existing entitlements may be retrieved by the entitlement clearance application 124 in the course of its operation.) The entitlement clearance application 124 may operate, for example, as described above with respect to process flow 200, to generate a list of conflicts, if any, caused by each new entitlement at 513. At 514, the list of conflicts may be sent to a human or automated reviewer. At 516, the reviewer may determine whether to resolve any of the identified conflicts by maintaining or revoking the affected entitlements. If any entitlements are indicated by the reviewer to be revoked, a de-provisioning command may be executed at 518 to revoke the entitlements. If any conflicts remain at 520, the entitlement conflict exception application 122 may be called at 524. If the application 122 results in the approval of the remaining conflicts, then an entitlement provisioning command (e.g., application 120 or 114) to provision the new entitlements at 522. In the event that no conflicts remain at 520, then the provisioning command may be utilized at that point to provision the new entitlements. If conflicts remain then the affected entitlement or entitlements may be revoked (if they have already been provisioned) or refused.

FIG. 6 illustrates a hardware diagram of one embodiment of a computer system 600 that may implement entitlements conflict enforcement, as described herein. In various embodiments, the computer system 600 may be a computer system implemented by a single business firm, such as a financial services firm. In other embodiments, however, a portion of the system 600 components may be external to the business entity. The computer system 600 may comprise various servers 606, databases 608, mobile computers 612, and other computers 610. These computer devices 606, 608, 610, 612 may, individually or collectively, store and manage firm data resources, implement applications for accessing firm data resources and/or implement applications for executing certain business transactions by automated or manual means. Also, for example, the computer devices 606, 608, 610, 612 may execute one or more instances of the entitlement clearance applications, entitlement provisioning applications, and entitlement conflict exception applications described herein. The various computer devices 606, 608, 610, 612 may communicate with one another via one or more networks 602, 604. The networks 602, 604 may be or comprise any form of wired, wireless or other network. The example embodiment shown in FIG. 6 illustrates two local area networks 602 that communicate with one another via a wide area network 604. Some of the computer devices 606, 608, 610, 612 may communicate via the local area networks 602, while others may bypass the local area networks 602 and communicate directly via the wide area network 602. In various embodiments, communications between the various computer devices 606, 608, 610, 612 may be secured according to any suitable encryption or other method.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, methods or processing structures described herein are necessarily intended to limit the scope of the invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused descriptions would not facilitate a better understanding of the present invention, and therefore, a more detailed description of such elements is not provided herein.

In various embodiments, modules or software can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention.

Moreover, the processes associated with the present embodiments may be executed by programmable equipment, such as computers. Software or other sets of instructions that may be employed to cause programmable equipment to execute the processes. The processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

A “computer,” “computer system,” “host,” “engine,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

Various embodiments of the systems and methods described herein may employ one or more electronic computer networks to promote communication among different components, transfer data, or to share resources and information. Such computer networks can be classified according to the hardware and software technology that is used to interconnect the devices in the network, such as optical fiber, Ethernet, wireless LAN, HomePNA, power line communication or G.hn. The computer networks may also be embodied as one or more of the following types of networks: local area network (LAN); metropolitan area network (MAN); wide area network (WAN); virtual private network (VPN); storage area network (SAN); or global area network (GAN), among other network varieties.

For example, a WAN computer network may cover a broad area by linking communications across metropolitan, regional, or national boundaries. The network may use routers and/or public communication links. One type of data communication network may cover a relatively broad geographic area (e.g., city-to-city or country-to-country) which uses transmission facilities provided by common carriers, such as telephone service providers. In another example, a GAN computer network may support mobile communications across multiple wireless LANs or satellite networks. In another example, a VPN computer network may include links between nodes carried by open connections or virtual circuits in another network (e.g., the Internet) instead of by physical wires. The link-layer protocols of the VPN can be tunneled through the other network. One VPN application can promote secure communications through the Internet. The VPN can also be used to separately and securely conduct the traffic of different user communities over an underlying network. The VPN may provide users with the virtual experience of accessing the network through an IP address location other than the actual IP address which connects the access device to the network.

Computer networks may include hardware elements to interconnect network nodes, such as network interface cards (NICs) or Ethernet cards, repeaters, bridges, hubs, switches, routers, and other like components. Such elements may be physically wired for communication and/or data connections may be provided with microwave links (e.g., IEEE 802.12) or fiber optics, for example. A network card, network adapter or NIC can be designed to allow computers to communicate over the computer network by providing physical access to a network and an addressing system through the use of MAC addresses, for example. A repeater can be embodied as an electronic device that receives and retransmits a communicated signal at a boosted power level to allow the signal to cover a telecommunication distance with reduced degradation. A network bridge can be configured to connect multiple network segments at the data link layer of a computer network while learning which addresses can be reached through which specific ports of the network. In the network, the bridge may associate a port with an address and then send traffic for that address only to that port. In various embodiments, local bridges may be employed to directly connect local area networks (LANs); remote bridges can be used to create a wide area network (WAN) link between LANs; and/or, wireless bridges can be used to connect LANs and/or to connect remote stations to LANs.

In various embodiments, a hub may be employed which contains multiple ports. For example, when a data packet arrives at one port of a hub, the packet can be copied unmodified to all ports of the hub for transmission. A network switch or other devices that forward and filter OSI layer 2 datagrams between ports based on MAC addresses in data packets can also be used. A switch can possess multiple ports, such that most of the network is connected directly to the switch, or another switch that is in turn connected to a switch. The term “switch” can also include routers and bridges, as well as other devices that distribute data traffic by application content (e.g., a Web URL identifier). Switches may operate at one or more OSI model layers, including physical, data link, network, or transport (i.e., end-to-end). A device that operates simultaneously at more than one of these layers can be considered a multilayer switch. In certain embodiments, routers or other like networking devices may be used to forward data packets between networks using headers and forwarding tables to determine an optimum path through which to transmit the packets.

As employed herein, an application server may be a server that hosts an API to expose business logic and business processes for use by other applications. Examples of application servers include J2EE or Java EE 5 application servers including WebSphere Application Server. Other examples include WebSphere Application Server Community Edition (IBM), Sybase Enterprise Application Server (Sybase Inc), WebLogic Server (BEA), JBoss (Red Hat), JRun (Adobe Systems), Apache Geronimo (Apache Software Foundation), Oracle OC4J (Oracle Corporation), Sun Java System Application Server (Sun Microsystems), and SAP Netweaver AS (ABAP/Java). Also, application servers may be provided in accordance with the .NET framework, including the Windows Communication Foundation, .NET Remoting, ADO.NET, and ASP.NET among several other components. For example, a Java Server Page (JSP) is a servlet that executes in a web container which is functionally equivalent to CGI scripts. JSPs can be used to create HTML pages by embedding references to the server logic within the page. The application servers may mainly serve web-based applications, while other servers can perform as session initiation protocol servers, for instance, or work with telephony networks. Specifications for enterprise application integration and service-oriented architecture can be designed to connect many different computer network elements. Such specifications include Business Application Programming Interface, Web Services Interoperability, and Java EE Connector Architecture.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as set forth in the appended claims.

We claim:

1. A computer system for detecting entitlements conflicts, the system comprising at least one computer device comprising at least one processor and operatively associated storage, wherein the storage comprises instructions that, when executed by the at least one processor, cause the at least one computer device to execute an entitlements clearance application, wherein the entitlements clearance application is programmed to:
receive from a provisioning application an entitlement clearance request, wherein the entitlement clearance request comprises an indication of a subject entitlement and an indication of a subject user;
receive an indication of user characteristics describing the subject user;
receive an indication of existing entitlements held by the subject user;
apply a plurality of entitlements conflict rules to the existing entitlements, the subject entitlement and the user characteristics to determine whether an entitlements conflict exists in view of the subject entitlement; and
return a completion indication of whether the entitlements conflict exists in view of the subject entitlement, wherein, provided that the entitlements conflict exists, the completion indication comprises an indication of at least one entitlements conflict rule selected from the plurality of entitlements conflict rules that would be violated by the subject entitlement.

2. The computer system of claim 1, wherein the indication of the subject entitlement comprises an indication of an asset that would be entitled by the subject entitlement.

3. The computer system of claim 1, wherein the indication of the subject user comprises an employee identifier of the subject user and an identifier of a department associated with the subject user.

4. The computer system of claim 1, wherein the entitlement is selected from the group consisting of a right to authorize an action and access to a resource.

5. The computer system of claim 1, wherein applying the plurality of entitlements conflict rules to the existing entitlements and the subject entitlement further comprises:
generating a combined entitlement set comprising the subject entitlement and the existing entitlements held by the subject user;
applying a plurality of organization-based conflict rules to the combined entitlement set; and
applying a plurality of application-based conflict rules to the combined entitlement set.

6. The computer system of claim 5, wherein, provided that the entitlements conflict exists, the completion indication comprises an indication of whether the at least one entitlements conflict rule selected from the plurality of entitlements conflict rules that would be violated in view of the subject entitlement comprises an organization-based entitlements conflict rule or an application-based conflict rule.

7. The computer system of claim 1, wherein, provided that the entitlements conflict does not exist, the completion indication comprises an indication of no conflict.

8. The computer system of claim 1, wherein, provided that the entitlements conflict exists, the completion indication comprises a list of conflicting entitlements selected from the group consisting of the subject entitlement and the existing entitlements.

9. The computer system of claim 1, wherein the storage further comprises instructions that, when executed by the at least one processor, cause the at least one computer device to execute an entitlement conflict exception application, wherein the entitlement conflict exception application is programmed to:
receive an exception request for an exception to at least one entitlements conflict, wherein the exception request indicates the subject entitlement, at least one of the plurality of entitlements conflict rules violated by the subject entitlement at least one of a user characteristic that conflicts with the subject entitlement and an entitlement selected from the existing entitlements held by the subject user that conflicts with the subject entitlements.

10. The computer system of claim 9, wherein the entitlement conflict exception application is further programmed to:
provide the exception request to an administrative user; and
return an indication of whether the exception request will be granted.

11. The computer system of claim 1, wherein the storage further comprises instructions that, when executed by the at least one processor, cause the at least one computer device to execute the provisioning application, wherein the provisioning application is programmed to:
receive a request for the subject entitlement;
call the entitlement clearance application, wherein the call to the entitlement clearance application comprises the indication of the subject entitlement and the indication of the subject user.

12. The computer system of claim 11, wherein the provisioning application is further programmed to, provided that the segregation of duties violation would exist, send the exception request to the exception approval application.

13. The computer system of claim 1, wherein the entitlement clearance application is further programmed to:
provided that the entitlements conflict exists, send the exception request to the exception approval application; and
return the indication of whether exception request will be granted.

14. The computer system of claim 1, wherein the storage further comprises instructions that, when executed by the at least one processor, cause the at least one computer device to execute the provisioning application, wherein the provisioning application is programmed to:
receive an indication of a reference data change;
derive at least one entitlement related to the subject user that will change as a result of the reference data change; and
generate the entitlement clearance request, wherein the subject entitlement comprises the at least one entitlement related to the subject user that will change as a result of the reference data change.

15. The computer system of claim 14, wherein the reference data change is selected from the group consisting of:
the subject user moving from a first team to a second team, wherein entitlements of members of the first group are different than entitlements of members of the second group; and
a change in a role of the subject user.

16. The computer system of claim 1, wherein the entitlement clearance request comprises an indication of a plurality of subject entitlements including the subject entitlement and wherein the plurality of conflict clearance rules are applied in view of the plurality of subject entitlements.

17. The computer system of claim 1, wherein the entitlement clearance request comprises an indication of a plurality of subject users including the subject user and wherein the plurality of conflict clearance rules are applied in view of the plurality of subject users.

18. A computer-implemented method for detecting entitlements conflicts, the method comprising:
receiving by a computer device from a provisioning application an entitlement clearance request, wherein the entitlement clearance request comprises an indication of a subject entitlement and an indication of a subject user, and wherein the computer device comprises at least one processor and operatively associated storage;
receiving by the computer device an indication of user characteristics describing the subject user;
receiving by the computer device an indication of existing entitlements held by the subject user;
applying by the computer device a plurality of entitlements conflict rules to the existing entitlements, the subject entitlement and the user characteristics to determine whether an entitlements conflict exists in view of the subject entitlement; and
returning by the computer device a completion indication of whether the entitlements conflict exists in view of the subject entitlement, wherein, provided that the entitlements conflict exists, the completion indication comprises an indication of at least one entitlements conflict rule selected from the plurality of entitlements conflict rules that would be violated by the subject entitlement.

19. The method of claim 18, wherein, provided that the entitlements conflict exists, the completion indication comprises an indication of whether the at least one entitlements conflict rule selected from the plurality of entitlements conflict rules that would be violated in view of the subject entitlement comprises an organization-based entitlements conflict rule or an application-based conflict rule.

20. The method of claim 18, further comprising receiving an exception request for an exception to at least one entitlements conflict, wherein the exception request indicates the subject entitlement, at least one of the plurality of entitlements conflict rules violated by the subject entitlement at least one of a user characteristic that conflicts with the subject entitlement and an entitlement selected from the existing entitlements held by the subject user that conflicts with the subject entitlements.
